(19) United States
(12) Patent Application Publication
(10) Pub. No.: US 2008/0305769 A1
(43) Pub. Date: Dec. 11, 2008

(54) Device Method & System For Facilitating Mobile Transactions

(76) Inventor: Nahum Rubinstein, Rishon Lezion (IL)

Correspondence Address: Professional Patent Solutions, P.O. BOX 654, HERZELIYA PITUACH, 46105, IL

(21) Appl. No.: 11/759,957

(22) Filed: Jun. 8, 2007

(51) Int. Cl. H04M 1/66

(52) U.S. Cl. 455/411

(57) ABSTRACT

Disclosed is a method and system for facilitating secure transactions via mobile devices such as cell-phones, smart-phones, person digital assistants (“PDA”) and the like. According to some embodiments of the present invention, there is provided a system and method for authenticating a user via multi-factor authentication. According to further embodiments of the present invention, a user engaging in a transaction associated with a given transaction system (e.g. banking network, etc.) and requiring authentication may be authenticated using a combination of two or more keys, where a first key may be stored on a mobile device used as an interface to the transaction system, and where a second key may be stored on a digital key storage device functionally associated with the mobile device.

### FIELD OF THE INVENTION

The present invention relates to the field authenticating users of a secure system. More specifically, the present invention relates to a system and method for authenticating users via multi-factor authentication.

### BACKGROUND

Today's cellular phones go far beyond their original purpose of voice communication. They now support text messaging, Internet access, entertainment packages, photography and more. The probability for even greater functionality is high, driven by three related forces: consumer demand, market competition and mobile infrastructure improvements.

Another field that is in constant growth is electronic payments. Ongoing advancements in mobile payments technologies, such as RFID, Near Field Communications (NFC) and Short Message Service (SMS) have helped spark the growth of contactless payments, such as MasterCard's PayPass, which is based on NFC technology, and PayPal Mobile, which uses SMS.

A major issue with electronic payment services, and specifically mobile payment services, is authentication: mobile systems lack the authenticity of physical transactions and the easy input methods of a personal computer. In addition, mobile devices are prone to theft, which precludes storing strong authentication tokens on them.

There are many systems that require user access. Some have many users and require authorized users to log in. Some require user identification to access a particular portion or aspect of the system. Some contain personal information. There are many reasons to restrict access to these systems to authorized users. Authorized users have to be identified before access can be granted.

For example, computer systems and subsystems are well known in the art. For security and privacy purposes, some computer systems include user identification protocols to limit access to authorized or validated users. For example, protocols are often put in place to limit access to the system, to a particular subsystem or other portion of the system, to particular databases, or to certain applications, documents and portions of documents, objects, and workstations. As used herein, the term “system” will be used to mean any of these entities. Such validation protocols are useful to the extent that they can provide reliable identification of an authorized user, and do not mis-identify an unauthorized user.

A conventional user identification protocol requires users to submit knowledge-based data, such as a password and user ID, in order to gain access to a computer system. A submitted user ID may be used to reference a password associated with the user ID, with the passwords being compared to determine whether a particular user is authorized to access the system. A benefit of knowledge-based identification protocols is that access to requisite knowledge-based data can be totally unavailable to unauthorized entities, which increases the overall strength of the protocol. For example, a user is not required to record knowledge-based data anywhere other than in the user's memory, that is, in the user's brain.

However, most knowledge-based identification protocols suffer from an inherent problem. To prevent the hacking or spoofing of the knowledge-based data, the complexity of the data can be increased. For example, longer or more complicated passwords can be specified to make guessing of the password less likely. However, knowledge-based data that is too complex might result in an unacceptably high rate of false negatives (for example, forgotten and/or mistyped data) or in weakened password practice (for example, users might perceive the need to record such data in insecure ways, such as on paper, because the data is too difficult to memorize). Similarly, to avoid such problems, the complexities of the knowledge-based data can be decreased. However, such a decrease in complexity can increase the protocol's susceptibility to hacking or spoofing.

Another conventional user identification protocol requires users to submit possession-based data, such as an authorization code stored on an access pass (for example, a magnetic-stripe card, a smart card or a security token), and the submitted code is evaluated to determine user access. A benefit of possession-based identification protocols is that the requisite possession-based data can be extraordinarily complicated, in order to minimize the likelihood that such data is hacked or spoofed. Another benefit is that possession-based data does not require memorization of the data by a user, so that complexity limitations can be avoided.

However, possession-based identification protocols suffer from a potential weakness. Possession-based data (that is, the data stored on the token or other storage medium) can be stolen or lost. Thus, someone who steals or otherwise obtains a user's access pass can spoof the protocol by mere possession of the access pass. Likewise, if the access pass is lost, a “false negative” is assured until it is replaced.

Another conventional user identification protocol requires users to submit biometric-based data, such as a fingerprint scan, for example, and this biometric data is evaluated to determine user access. Such an identification protocol generally includes two stages: enrollment and identification. During enrollment, a biometric instance (such as a fingerprint scan) is obtained, and unique characteristics or features of the biometric instance are extracted to form a biometric template, which is stored as an enrollment template for subsequent identification purposes. Identification involves obtaining a subsequent biometric instance reading of the same type, extracting unique characteristics or features of the subsequent biometric instance to form a new template (the verification template), and comparing the two biometric templates to determine identification of the user. A benefit of biometric-based identification protocols is that the requisite biometric-based data is unique, which minimizes the likelihood of such data being hacked or spoofed. Another benefit is that biometric-based data also does not require memorization of the data by a user.

However, some biometric-based identification protocols suffer from potential weaknesses. Biometric-based data samples of a particular user can be inconsistent from one sampling to another, and therefore these protocols can be subject to false negatives. To improve the reliability of biometric samplings, a larger biometric measurement may be sampled, in order to reduce the likelihood of false negatives. For example, a commercial solution known as Bioscript.™. (Bioscript, Inc., Mississauga, Ontario, Canada) utilizes such a methodology to account for distortions, such as cuts, scratches and other day-to-day variations of a user's fingerprint. However, increasing the size or scope of a biometric sample also increases the costs (such as electrical power, time, processing power, design and other implementation costs, training) incurred in utilizing a larger sample.

Therefore, it would be desirable to provide a method of identifying a user for access to a system that improves on conventional methods. It would also be desirable to provide an apparatus for enabling improved user identification techniques. It would also be desirable to provide a system to implement and utilize an improved method of identifying a user for access to a system. It would also be desirable if the number of additional devices that the user has to carry on his person could be minimized. Since most people carry mobile phones, these can be used as an authentication device.

### SUMMARY OF THE INVENTION

The present invention is a method and system for facilitating secure transactions via mobile devices such as cell-phones, smart-phones, person digital assistants (“PDA”) and the like. According to some embodiments of the present invention, there is provided a system and method for authenticating a user via multi-factor authentication.

According to some embodiments of the present invention, a user engaging in a transaction associated with a given transaction system (e.g. banking network, etc.) and requiring authentication may be authenticated using a combination of two or more keys, where a first key may be stored on a mobile device used as an interface to the transaction system, and where a second key may be stored on a digital key storage device functionally associated with the mobile device.

According to some embodiments of the present invention, the mobile device may communicate with the transaction system over a wireless network such as a cellular network, a WiFi network or a WiMax network. According to some embodiments of the present invention, communication between the mobile device and the transaction system may be encrypted. The transaction system may include an encryption engine configured to participate in an encrypted communication session with the mobile device, where at least part of the encryption scheme is based on data derived from one or both of the digital keys functionally associated with the mobile device and/or the mobile device user. Encryption may also be partly based on personal identification data of the mobile device user (e.g. Personal Identification Number “PIN”, fingerprint data, voice print data, or any other biometric data).

According to some embodiments of the present invention, the transaction system may include an authentication server which may require the mobile device and/or the mobile device user to be authenticated. Authentication may be based on one or more digital keys functionally associated with the mobile device. According to further embodiments of the present invention, authentication may also be based on personal identification data of the mobile device user (e.g. Personal Identification Number “PIN”, fingerprint data, voice print data, or any other biometric data).

According to some embodiments of the present invention, the mobile device may transmit to the transaction system data derived from at least two digital keys, where one digital key may be stored on the mobile device and the other digital key may be stored on a digital key storage device which device may be functionally associated with the mobile device. According to further embodiments of the present invention, the digital key storage device may be functionally associated with the mobile device via a wireless data link. The wireless data link may be based on a Bluetooth protocol, a WiFi protocol, or on any other wireless protocol and technology known today or to be devised in the future.

According to some embodiments of the present invention, the mobile device may encrypt some or all of its communication with the transaction system using a digital key specifically made for use in the current communication session (session key). According to further embodiments of the present invention, the session key may be supplied by the digital key storage device. According to further embodiments of the present invention, the session key may be derived from the digital key stored in the digital key storage device.

According to some embodiments of the present invention, the key storage device may include an encryption engine adapted to encrypt or aid in encryption of the communication session between the mobile device and the remote transaction system.

According to some embodiments of the present invention, the temporary digital key generated by the encryption engine may be based on data provided by the transaction system. According to alternative embodiments of the present invention, the temporary digital key generated by the encryption engine may be based on data provided by the mobile device.

According to some embodiments of the present invention, the encryption engine may include a time-dependent component, such that the data stream cannot be replayed or repeated by an attacker.

According to some embodiments of the present invention, the authentication may comprise an authentication key stored in a digital Memory (e.g. RAM, Flash RAM, ROM, etc.), functionally associated with a Bluetooth wireless communication module. According to further embodiments of the present invention, upon request for authentication, the mobile device may establish communication with the key storage device and pass the key stored on it to the transaction system.

According to alternative embodiments of the present invention, the mobile device may use the key stored on the key storage device to encrypt some or all of its communication with the requesting server.

According to alternative embodiments of the present invention, the key storage device and the mobile device may authenticate each other. According to some further embodiments of the present invention, the mutual authentication process may not require the mobile device to receive the key stored on the key storage device.

According to some embodiments of the present invention, should the mobile device fail to establish communication with the key storage device, it may prompt the user for an alternative secondary authentication, such as but not limited to voice signature, fingerprint, or any other authentication method known now or to be devised in the future.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing the functional blocks of a mobile device and a digital key storage device in accordance with some embodiments of the present invention;

FIG. 2a is a block diagram showing the functional blocks of a digital key storage device in accordance with some embodiments of the present invention;

FIG. 2b is a block diagram showing the functional blocks of a digital key storage device in accordance with some embodiments of the present invention;

FIG. 2c is a block diagram showing the functional blocks of a digital key storage device in accordance with some embodiments of the present invention; and

FIG. 3 is a flowchart illustrating the mobile device authentication process in accordance with some embodiments of the present invention.

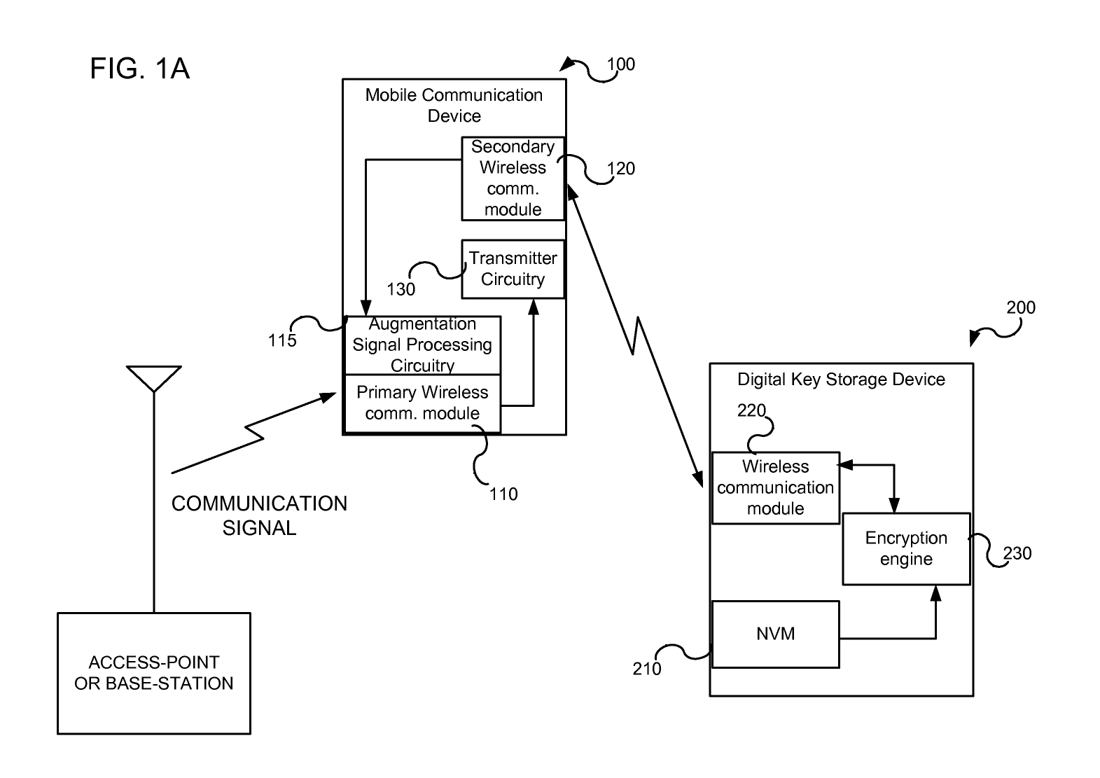

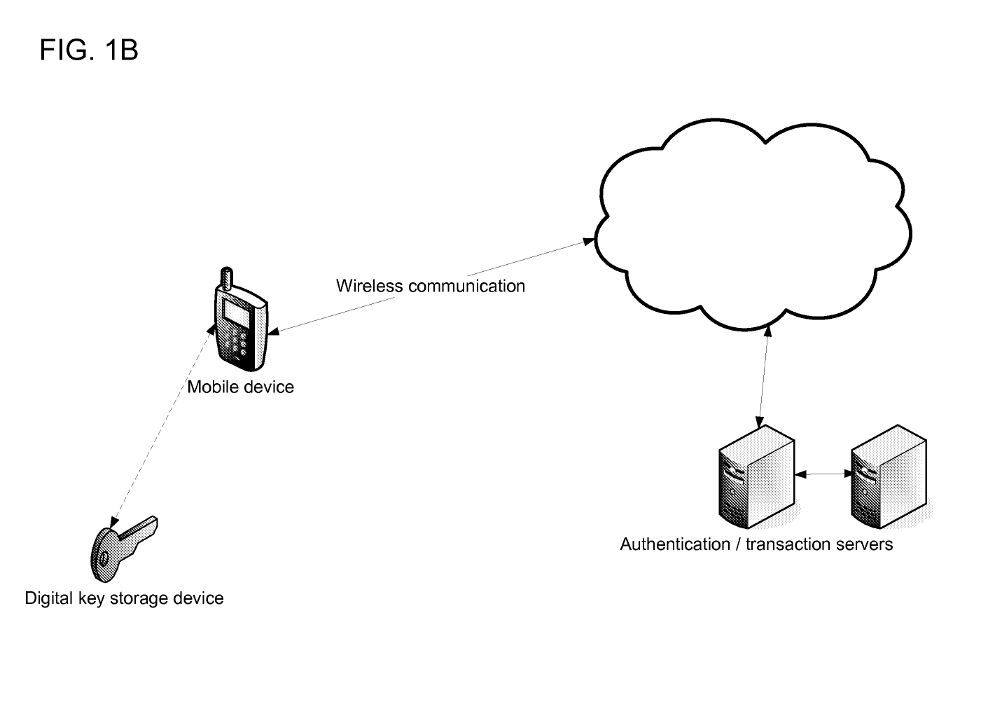

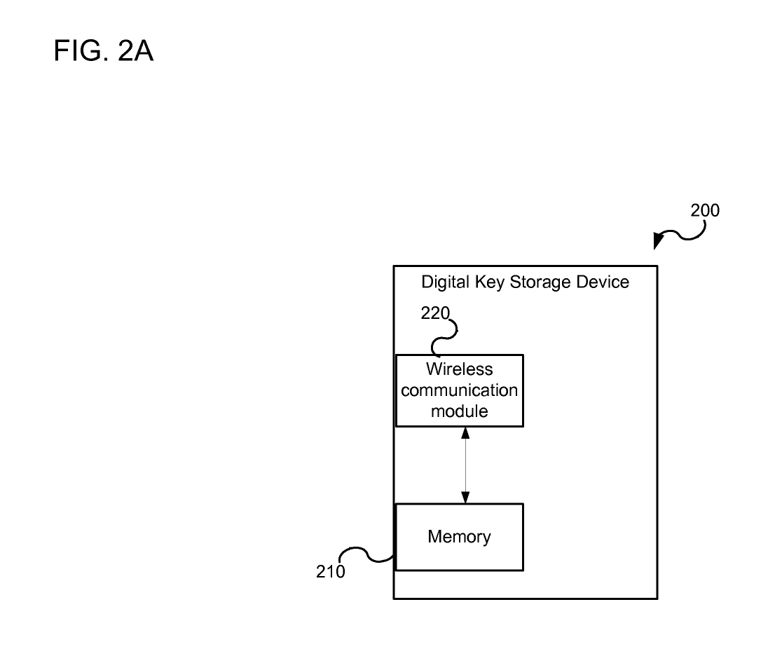

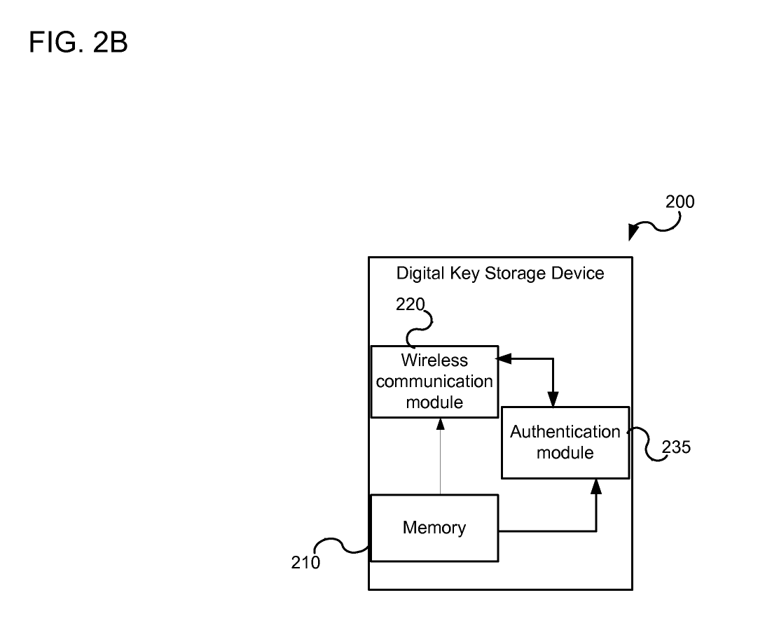

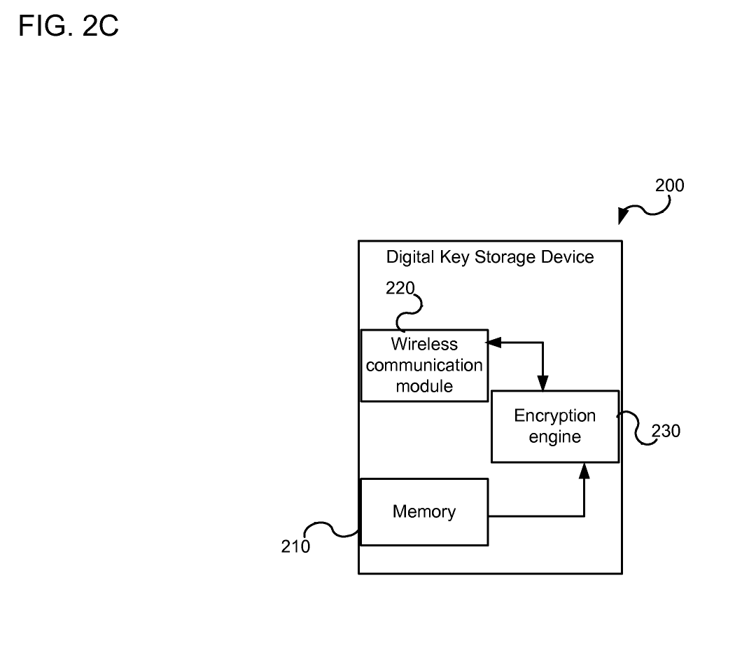

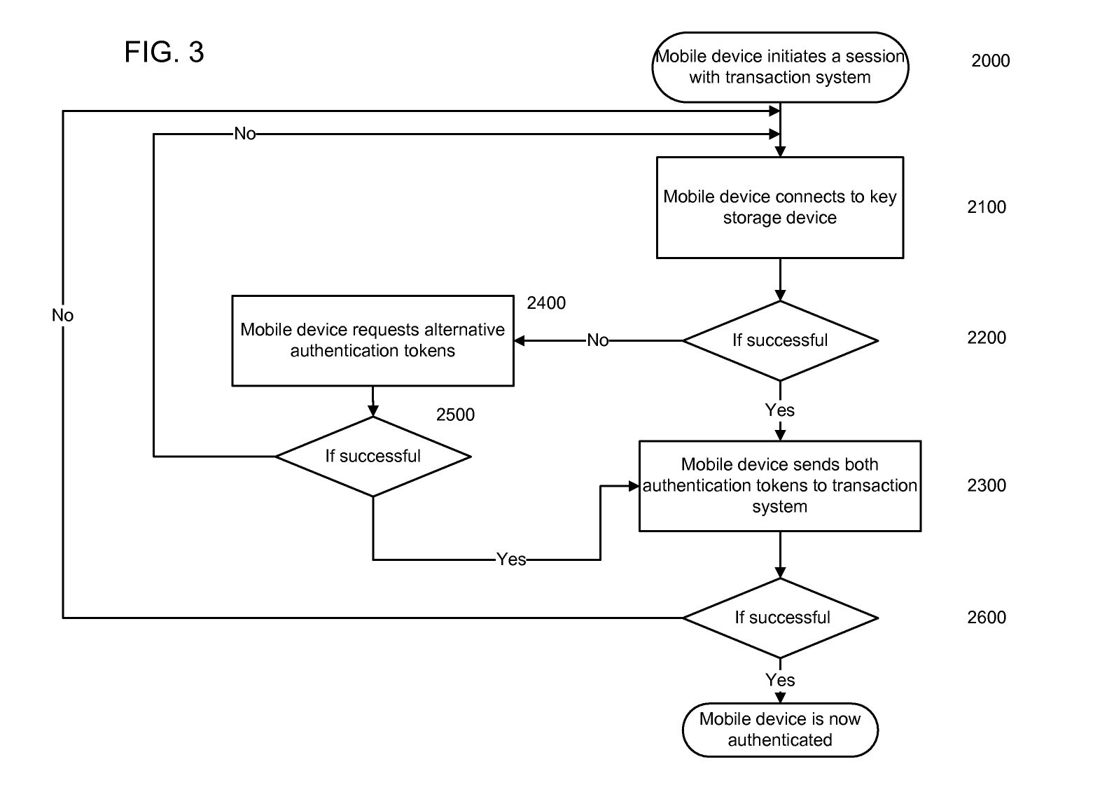

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a method and system for facilitating secure transactions via mobile devices such as cell-phones, smart-phones, person digital assistants (“PDA”) and the like. According to some embodiments of the present invention, there is provided a system and method for authenticating a user via multi-factor authentication.

According to some embodiments of the present invention, a user engaging in a transaction associated with a given transaction system (e.g. banking network, etc.) and requiring authentication may be authenticated using a combination of two or more keys, where a first key may be stored on a mobile device used as an interface to the transaction system, and where a second key may be stored on a digital key storage device functionally associated with the mobile device.

According to some embodiments of the present invention, the mobile device may communicate with the transaction system over a wireless network such as a cellular network, a WiFi network or a WiMax network. Communication between the mobile device and the transaction system may be encrypted. The transaction system may include an encryption engine configured to participate in an encrypted communication session with the mobile device, where at least part of the encryption scheme is based on data derived from one or both of the digital keys functionally associated with the mobile device and/or the mobile device user. Encryption may also be partly based on personal identification data of the mobile device user (e.g. Personal Identification Number “PIN”, fingerprint data, voice print data, or any other biometric data).

The transaction system may include an authentication server which may require the mobile device and/or the mobile device user to be authenticated. Authentication may be based on one or more digital keys functionally associated with the mobile device. Authentication may also be based on personal identification data of the mobile device user (e.g. Personal Identification Number “PIN”, fingerprint data, voice print data, or any other biometric data).

According to some embodiments of the present invention, the mobile device may transmit to the transaction system data derived from at least two digital keys, where one digital key may be stored on the mobile device and the other digital key may be stored on a digital key storage device which device may be functionally associated with the mobile device. According to further embodiments of the present invention, the digital key storage device may be functionally associated with the mobile device via a wireless data link. The wireless data link may be based on a Bluetooth protocol, a WiFi protocol, or on any other wireless protocol and technology known today or to be devised in the future.

According to some embodiments of the present invention, the mobile device may encrypt some or all of its communication with the transaction system using a digital key specifically made for use in the current communication session (session key). According to further embodiments of the present invention, the session key may be supplied by the digital key storage device. According to further embodiments of the present invention, the session key may be derived from the digital key stored in the digital key storage device.

According to some embodiments of the present invention, the key storage device may include an encryption engine adapted to encrypt or aid in encryption of the communication session between the mobile device and the remote transaction system.

According to some embodiments of the present invention, the temporary digital key generated by the encryption engine may be based on data provided by the transaction system. According to alternative embodiments of the present invention, the temporary digital key generated by the encryption engine may be based on data provided by the mobile device.

According to some embodiments of the present invention, the encryption engine may include a time-dependent component, such that the data stream cannot be replayed or repeated by an attacker.

According to some embodiments of the present invention, the authentication may comprise an authentication key stored in a digital Memory (e.g. RAM, Flash RAM, ROM, etc.), functionally associated with a Bluetooth wireless communication module. According to further embodiments of the present invention, upon request for authentication, the phone may establish communication with the key storage device and pass the key stored on it to the transaction system.

According to alternative embodiments of the present invention, the mobile device may use the key stored on the key storage device to encrypt some or all of its communication with the requesting server.

According to alternative embodiments of the present invention, the key storage device and the mobile device may authenticate each other. According to some further embodiments of the present invention, the mutual authentication process may not require the mobile device to receive the key stored on the key storage device.

According to some embodiments of the present invention, should the mobile device fail to establish communication with the key storage device, it may prompt the user for an alternative secondary authentication, such as but not limited to voice signature, fingerprint, or any other authentication method known now or to be devised in the future.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A digital key storage device comprising:
a non-volatile memory adapted to store a digital key; and
a communication module adapted to provide a mobile communication device regulated access to data derived from the digital key stored on said non-volatile memory.

2. The device according to claim 1, further comprising a digital key generation module adapted to generate a session key based on the digital key stored on said non-volatile memory.

3. The device according to claim 2, wherein said digital key generation module is further adapted to generate a session key based on the digital key stored on said non-volatile memory and based on data provided by the mobile device.

4. The device according to claim 3, wherein the data provided by the device is a token sent to the device by a remote transaction system.

5. The device according to claim 3, wherein the data provided by the device is related to personal data provided by a user of the mobile device.

6. The device according to claim 5, wherein the personal data is selected from the group of data consisting of personal identification number, fingerprint data, voiceprint data, any biometric data.

7. A transaction system comprising:
a communication module adapted to communicate with a mobile device over a multifactor authentication secured communication session, wherein the multifactor authentication is based on at least one digital key stored on the mobile device and base on a digital key stored on a digital key storage device in wireless communication with the mobile device.

8. A mobile device comprising:
a communication module adapted to communicate with a transaction system over a multifactor authentication secured communication session, wherein the multifactor authentication is based on at least one digital key stored on said mobile device and base on a digital key stored on a digital key storage device in wireless communication with said mobile device.

9. The device according to claim 8, further comprising a second communication module adapted to engage in a wireless communication session with the digital key storage device.

10. The device according to claim 9, further comprising a user input unit adapted to receive user authentication data.

11. The device according to claim 8, further comprising a logic circuit adapted to process data associated with the multifactor authentication secured communication session.

12. Computer executable code stored on a digital storage medium and when executed by a processor of a mobile device said code adapted to cause the processor to configure a communication module to communicate with a transaction system over a multifactor authentication secured communication session, wherein the multifactor authentication is based on at least one digital key stored on said mobile device and base on a digital key stored on a digital key storage device in wireless communication with said mobile device.
